(19) United States
(12) Patent Application Publication
(10) Pub. No.: US 2025/0390298 A1
(43) Pub. Date: Dec. 25, 2025

(54) SOFTWARE DEVELOPMENT DOCUMENTATION GENERATION SYSTEM WITH ARTIFICIAL INTELLIGENCE-BASED PROCESSING OF DATA STRUCTURES

(71) Applicant: Dell Products L.P., Round Rock, TX (US)

(72) Inventors: Dev Kathuria, Greater Noida (IN); Ira Satvalekar, Karad (IN)

(21) Appl. No.: 18/747,787

(22) Filed: Jun. 19, 2024

(51) Int. Cl. G06F 8/73; G06F 8/41; G06N 3/096

(52) U.S. Cl. CPC G06F 8/73; G06F 8/447; G06N 3/096

(57) ABSTRACT

Methods, apparatus, and processor-readable storage media for software development documentation generation systems with artificial intelligence-based processing of data structures are provided herein. An example computer-implemented method includes compiling, from one or more data sources, information pertaining to at least one set of software code in one or more data structures; generating documentation associated with development of the at least one set of software code by processing at least a portion of the information in the one or more data structures using one or more artificial intelligence techniques; and performing one or more automated actions based at least in part on one or more portions of the generated documentation associated with the development of the at least one set of software code.

### BACKGROUND

Code development often generates a corresponding need for documenting information and/or actions associated with the code. However, the generation of such documentation is commonly neglected and/or overlooked, and conventional code development techniques typically rely on individuals (e.g., individuals who did not develop the code in question) to attempt to produce portions of the documentation after the code has been developed. Accordingly, such conventional approaches lead to error-prone and resource-intensive efforts which often result in a variety of code-related problems with respect, e.g., to code maintenance, code updates, code troubleshooting, etc.

### SUMMARY

Illustrative embodiments of the disclosure provide techniques for software development documentation generation systems with artificial intelligence-based processing of data structures.

An exemplary computer-implemented method includes compiling, from one or more data sources, information pertaining to at least one set of software code in one or more data structures, and generating documentation associated with development of the at least one set of software code by processing at least a portion of the information in the one or more data structures using one or more artificial intelligence techniques. Additionally, the method includes performing one or more automated actions based at least in part on one or more portions of the generated documentation associated with the development of the at least one set of software code.

Illustrative embodiments can provide significant advantages relative to conventional code development techniques. For example, problems associated with error-prone and resource-intensive efforts are overcome in one or more embodiments through automatically generating software development documentation using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically generating software development documentation using artificial intelligence techniques in an illustrative embodiment.

FIG. 2 shows example system architecture in an illustrative embodiment.

FIG. 3 shows an example workflow to fine-tune a large language model (LLM) as part of artificial intelligence-based documentation generator implementation in an illustrative embodiment.

FIG. 4 shows an example workflow for processing data for LLM fine-tuning in an illustrative embodiment.

FIG. 5 is a flow diagram of a process for automatically generating software development documentation using artificial intelligence techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

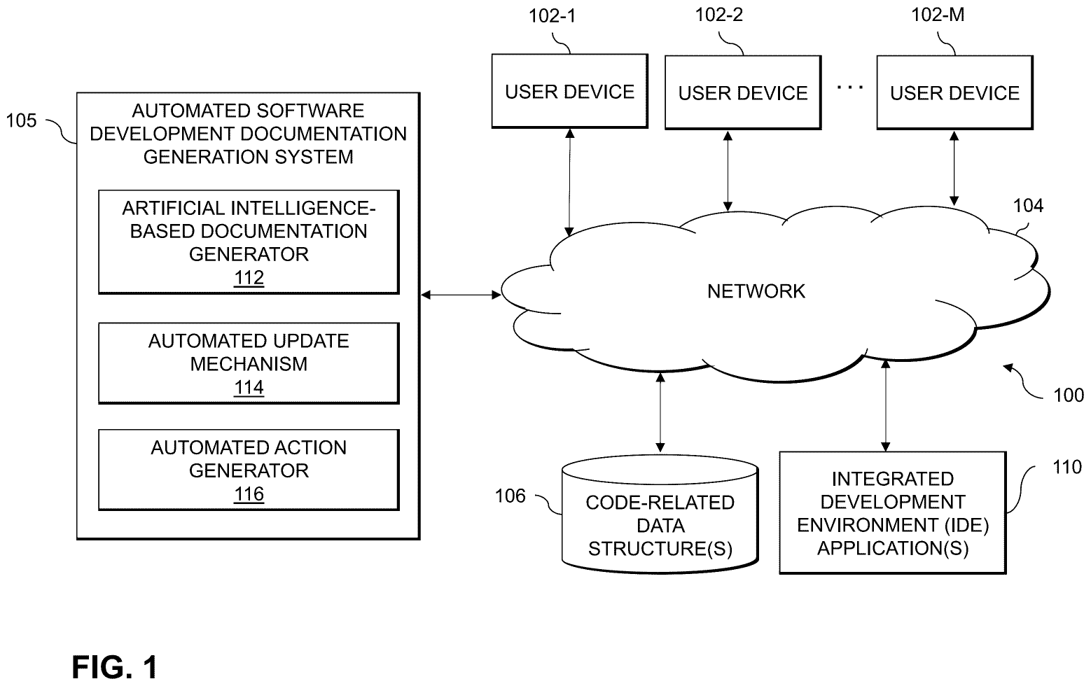

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated software development documentation generation system 105 and one or more integrated development environment (IDE) applications 110 (e.g., via which one or more of the user devices 102 can build, test, edit, etc. software code).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated software development documentation generation system 105 can have one or more associated code-related data structures 106 (also referred to herein as a data harbor) configured to store data, across one or more data structures, pertaining to codebases, commits, branches, properties, metadata, continuous integration and continuous delivery (CICD) pipelines, code features, deployed code versions, corresponding non-production and/or production environments, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The code-related data structure(s) 106 in the present embodiment is implemented using one or more storage systems associated with the automated software development documentation generation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated software development documentation generation system 105 are one or more input-output devices, which illustratively comprise keyboards, displays or other types of input-output devices in any combination. Such input-output devices can be used, for example, to support one or more user interfaces to the automated software development documentation generation system 105, as well as to support communication between the automated software development documentation generation system 105 and other related systems and devices not explicitly shown.

Additionally, the automated software development documentation generation system 105 in the FIG. 1 embodiment is assumed to be implemented using at least one processing device. Each such processing device generally comprises at least one processor and an associated memory, and implements one or more functional modules for controlling certain features of the automated software development documentation generation system 105.

More particularly, the automated software development documentation generation system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated software development documentation generation system 105 to communicate over the network 104 with the user devices 102, and illustratively comprises one or more conventional transceivers.

The automated software development documentation generation system 105 further comprises an artificial intelligence-based documentation generator 112, an automated update mechanism 114, and an automated action generator 116.

It is to be appreciated that this particular arrangement of elements 112, 114 and 116 illustrated in the automated software development documentation generation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically generating software development documentation using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated software development documentation generation system 105, code-related data structure(s) 106, and IDE application(s) 110 can be on and/or part of the same processing platform.

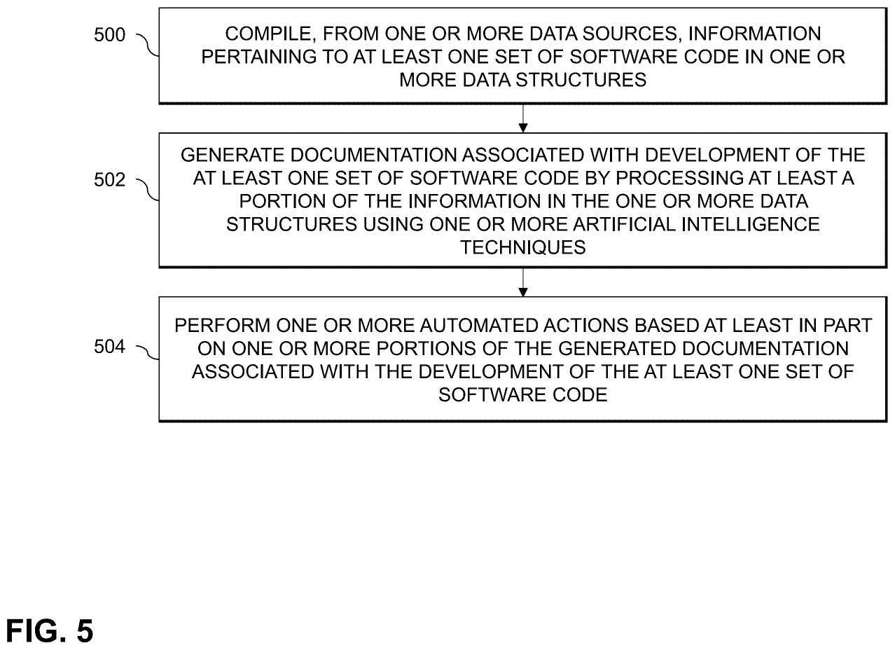

An exemplary process utilizing elements 112, 114 and 116 of an example automated software development documentation generation system 105 in computer network 100 will be described in more detail with reference to the flow diagram of FIG. 5.

Accordingly, at least one embodiment includes automatically generating software development documentation using artificial intelligence techniques. For example, such an embodiment includes automatically generating and maintaining technical documentation for software development projects by integrating with one or more software development life cycle (SDLC) tools and platforms (e.g., Git, Jira, Pivotal Cloud Foundry (PCF), etc.). As further detailed herein, by automating the generation and updating of technical documentation, such an embodiment can include increasing the efficiency of code development and/or code testing, as well as providing standardized up-to-date information code-related information such as, e.g., code features, code defects, and code deployment status. Further, one or more embodiments also include continuously updating the documentation based at least in part on any detected changes with respect to the code in question.

At least one embodiment includes leveraging and/or utilizing one or more LLMs to generate code development documentation. More particularly, one or more embodiments include training and/or fine-tuning one or more LLMs using at least one low-rank adaptation (LoRA) approach for technical document creation. As used herein, LoRA includes an example parameter efficient fine-tuning (PEFT) algorithm. In such an embodiment, a fine-tuned LLM can be used to generate code development documentation using data derived from various code-related tools such as, for example, at least one version control system (VCS), at least one application lifecycle management (ALM) system, at least one cloud native development system, etc.

More particularly, one or more embodiments can include integrating with at least one VCS to parse one or more code repositories and one or more code properties, including, e.g., commit history as well as associated branches and metadata. Such an embodiment can include using such information to identify one or more code changes, one or more code additions, one or more code deletions, and/or one or more connections between different code components and new code features. At least portions of such information can be fed as input to at least one LLM to update technical documentation, associated with given code, with relevant details about the codebase.

Also, at least one embodiment can include integrating with at least one project management platform to retrieve code-related information about one or more story enhancements, one or more linked features, one or more defect reports, etc. As used herein, a story refers to a project management platform entry and/or element which can be used to track development effort and/or progress. At least portions of such information can be leveraged by at least one LLM and included in the technical documentation to provide one or more insights into the development history, one or more planned features, and/or one or more known issues associated with the code and/or software corresponding thereto.

Additionally or alternatively, one or more embodiments can include integrating with one or more cloud platforms (e.g., such as PCF) to track the versions of the code and/or corresponding software that have been deployed, as well as the deployment environments and associated environment variables. At least portions of such information can be leveraged by at least one LLM and included in the technical documentation to provide visibility into the deployment history and the currently running version of the software, as well as to facilitate efficient debugging for production issues and/or defects. Accordingly, the availability of information from multiple domains of the feature (e.g., testing, development, etc.) on one document will enable users to determine and/or identify one or more breaking functionalities, flaws, and/or gaps at a single sight and make it easier to debug by reaching out to a respective team and/or engage with a faulty part of the integration and/or code.

As noted herein, at least one embodiment also includes implementing automated updates to code development documentation. For example, such an embodiment can include implementing one or more webhooks for continuously monitoring one or more integrated data sources (e.g., observer sites) for changes to the given code, such as new code commits, new deployments, updated stories and/or features, etc. When a change is detected, such an embodiment can include automatically updating the corresponding technical documentation with the relevant information.

By way merely of example, consider a use case involving implementing a representational state transfer (REST) application programming interface (API) webservice application. The developer, after writing and committing the code to a code repository (e.g., GitLab), deploys the code on a cloud computing platform (e.g., PCF) server in a non-production testing environment, and eventually into a production environment. In such a scenario, one or more embodiments can include reading the corresponding codebase and noting all of the technical changes from the latest and/or most recent commits in the code and properties such as, e.g., endpoints, credentials, API calls, etc. Such an embodiment also includes scanning through story features to fetch relevant release tags, timelines, etc., and analyzing portions of the cloud computing platform (e.g., PCF) for the deployed version of the code, environment-related information, and one or more other variables. Based at least in part on any information derived from such scanning and analysis, the corresponding code development documentation will be updated with the code explanation, one or more new endpoints, endpoint credential information, business data with release targets, issues, defects, and stakeholder details, etc.

In contrast to conventional code development techniques and approaches, one or more embodiments provide benefits to various users and aspects of the code development ecosystem. For example, in accordance with one or more embodiments, code developers do not need to spend considerable time and resources manually updating documentation, product managers can obtain a comprehensive view of code changes without diving into technical details, and testing and validation processes are simplified by providing readily available testing endpoints and comprehensive change details.

Accordingly, as detailed herein, one or more embodiments include automatically creating and maintaining technical documentation pertaining to code development by using one or more LLMs fine-tuned through processes such as, e.g., parameter-efficient tuning methods (PETM), PEFT, etc. As used herein, PETM refers to techniques that fine-tune LLMs with minimal computational resources by adjusting only a small subset of the model's parameters. In at least one embodiment, LoRA can be used as a PETM or PEFT, wherein LoRA can include, for example, injecting two smaller matrices (e.g., matrix A and matrix B) into the model, wherein such matrices represent weight updates through low-rank decomposition. The original model's weights can remain mostly unchanged, with only the additional matrices being trained. As such, this type of method can significantly reduce the amount of video random-access memory (VRAM) and computational power required for fine-tuning, making it suitable for resource-constrained environments.

Further, by integrating data from one or more SDLC tools and/or one or more ALM tools, such an embodiment can include ensuring that the documentation is coherent and pertinent to the evolving codebase, particularly in an Agile development scenario wherein requirements can frequently evolve.

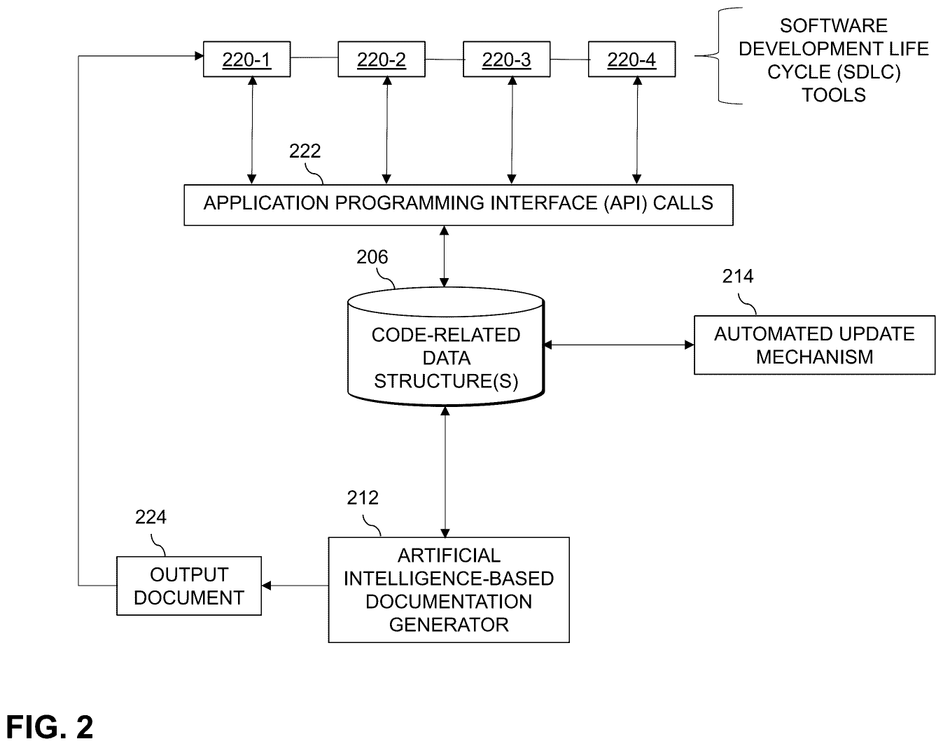

FIG. 2 shows example system architecture in an illustrative embodiment. By way of illustration, FIG. 2 depicts data fetched from SDLC tools 220-1, 220-2, 220-3, 220-4 (herein collectively referred to as SDLC tools 220) using one or more API calls 222 (e.g., one or more REST API calls). At least a portion of the data fetched from SDLC tools 220 is then stored in code-related data structure(s) 206, across one or more data structures, in conjunction with data from automated update mechanism 214. Based at least in part on processing one or more portions of such data stored in code-related data structure(s) 206 (e.g., processing at least a portion of the one or more data structures of code-related data structure(s) 206), artificial intelligence-based documentation generator 212 generates an output document 224 that pertains to the development and/or one or more updates to code associated with one or more of the SDLC tools 220. Additionally, at least portions of output document 224 are then input and/or provided to at least one of the SDLC tools 220.

As further detailed herein, one or more embodiments include implementing a data harbor, an artificial intelligence-based documentation generator, and an automated update mechanism. The data harbor can obtain and/or maintain code-related information derived from various tools and/or sources, wherein such information can include, for example, information related to at least one codebase, one or more commits, one or more branches, one or more properties, metadata, one or more CICD pipelines, etc. Additionally or alternatively, such information can include information related to at least one code feature and associated stories, issues, defects, etc., information related to deployed code versions, corresponding non-production and/or production environments, and variables related thereto, as well as information pertaining to existing documentation (e.g., which can be automatically updated when code changes are detected).

In one or more embodiments, the artificial intelligence-based documentation generator can include at least one fine-tuned LLM, which processes information from the data harbor. Such processing can include converting at least a portion of the information into at least one format suitable for documentation generation (e.g., at least one text format). Additionally, the artificial intelligence-based documentation generator creates and/or produces technical documentation associated with code development by combining various portions of the information derived from the data harbor.

Further, in at least one embodiment, the automated update mechanism implements a webhook-based technique to continuously monitor and/or detect changes in one or more code repositories and/or platforms. The automated update mechanism also processes information pertaining to any detected change and correlates at least a portion of the information to one or more platform (e.g., PCF) changes for updating the technical code documentation accordingly.

In such an embodiment, one or more webhooks can be configured and/or set-up to monitor one or more code repositories and/or platforms for any changes, such as new commits, deployments, updates to stories and/or features in one or more SDLC tools, etc. When a change is detected, the corresponding webhook triggers the extraction of relevant data, including code changes, commit messages, logs, updates in the ALM system, etc. Such an embodiment can then include processing such data to understand the change (e.g., analyzing commit messages and metadata to identify which files were modified, added, and/or deleted, and what features or bug fixes these changes pertain to). Additionally, such an embodiment can include identifying any changes in the corresponding codebase, such as addition of new features, bug fixes, refactoring, etc. Then, these changes can be matched with one or more corresponding stories, tasks, and/or deployment events. The existing documentation can be fed to the LLM, which integrates the new information to update the technical documentation for the corresponding tags on the document (e.g., the description titles, sections, categories, etc.).

As described above and further detailed herein, in at least one embodiment, a data harbor includes at least one specialized microservice architecture designed to fetch and aggregate data from various tools, sources and/or APIs to provide comprehensive insights into at least one specific code-related project. Such an embodiment can include implementing a data harbor to create a centralized hub of project-related data collected from various sources, and preprocess and organize such data in at least one format that can be fed to and/or processed by an artificial intelligence-based documentation generator. In one or more embodiments, such preprocessing can include, for example, making hypertext transfer protocol (HTTP) requests to one or more particular and/or respective APIs, handling related authentication requirements (e.g., through API tokens, OAuth, etc.), parsing JavaScript object notation (JSON) and/or extensible markup language (XML) responses, processing the collected data and feeding at least a portion of such data, as input, to the artificial intelligence-based documentation generator.

Additionally, one or more embodiments can include integrating data related to at least one VCS. Such data can include, e.g., repository details such as the code-related project name, description of the code-related project, identifying information and access permissions associated with the code-related project, and properties and/or manifests related to the code-related project. Also, such data can include data pertaining to commits made to a code-related repository, including commit messages, authors, timestamps, and associated branches. This type of data can facilitate the tracking of code changes in real-time. Further, such integrated data can also include merge request data related to the project, which can include information about open and closed merge requests, their status, one or more assignees, and one or more links to associated issues.

At least one embodiment can include integrating data related to one or more cloud deployments. Such data can include, e.g., application names, routes, and deployment status information, which can be collected with data pertaining to services provisioned for the project's applications, along with any bindings between applications and services. As used herein, a binding refers to application routes, application connections, and/or interconnected applications. This type of information can be used to facilitate the tracking of dependencies and configurations, along with performance metrics such as CPU usage, memory consumption, response times for the deployed applications, etc.

Additionally, at least one embodiment can also include integrating data related to one or more ALM systems, such as, e.g., data pertaining to project-specific issues, epic-related information including issue summaries, descriptions, issue types, epic names, etc. As used herein, an epic refers to a high-level feature of a story. Such data can also include data about project sprints and user stories, as well as information related to features such as the status of issues, including whether the issues are open, in progress, or resolved. This type of information can be used to facilitate the tracking of progress and sprint planning, assignees, and their workloads.

One or more embodiments can further include integrating data related to one or more documentation systems. In such an embodiment, a data harbor microservice interacts with one or more given APIs (e.g., a content management tool API) to retrieve documentation related to the project, including blog posts, attachments, etc.

Accordingly, in at least one embodiment, to fetch information about any functional flow, a data harbor microservice can call at least one relevant endpoint of a VCS and/or ALM system and/or deployment platform. Such an embodiment can include obtaining data in connection with reading through one or more repository files. Similarly, data related to branches, commits, etc., can be fetched through one or more REST API calls. Additionally or alternatively, cloud-based deployment platforms can facilitate one or more API GET calls to at least one domain and various endpoints to collect metadata and user-provided environment variables. Further, at least one ALM system can provide one or more GET call endpoints to search and load information related to any epic and/or story based on given identifiers (IDs).

The received responses from one or more API calls can be, for example, in the form of JSON payloads. Once received, the data harbor microservice can parse through the individual responses and clean and/or curate the data that is to be fed to the artificial intelligence-based documentation generator for generation of at least one comprehensive document. The obtained results can be paginated, and as such, one or more embodiments can include handling multiple requests to retrieve all of the corresponding data. In such an embodiment, emphasized points and/or parameters in the above-noted API calls can include “startAt” and “maxResults.” These parameters can be important because they can ensure obtainment of end-to-end data for any particular query and/or request, thereby enhancing accuracy in documentation generation.

As also detailed herein, one or more embodiments include training and/or fine-tuning one or more LLMs (e.g., H2O.ai, llama 2, pythia, generative pre-trained transformer-3.5 (GPT-3.5), GPT-4, etc.) to be used as part of at least one artificial intelligence-based documentation generator. Additionally, configuring such a model on one or more private servers can safeguard sensitive, confidential and/or proprietary information (e.g., enterprise information) relevant for fine-tuning the model to generate technical code development documentation.

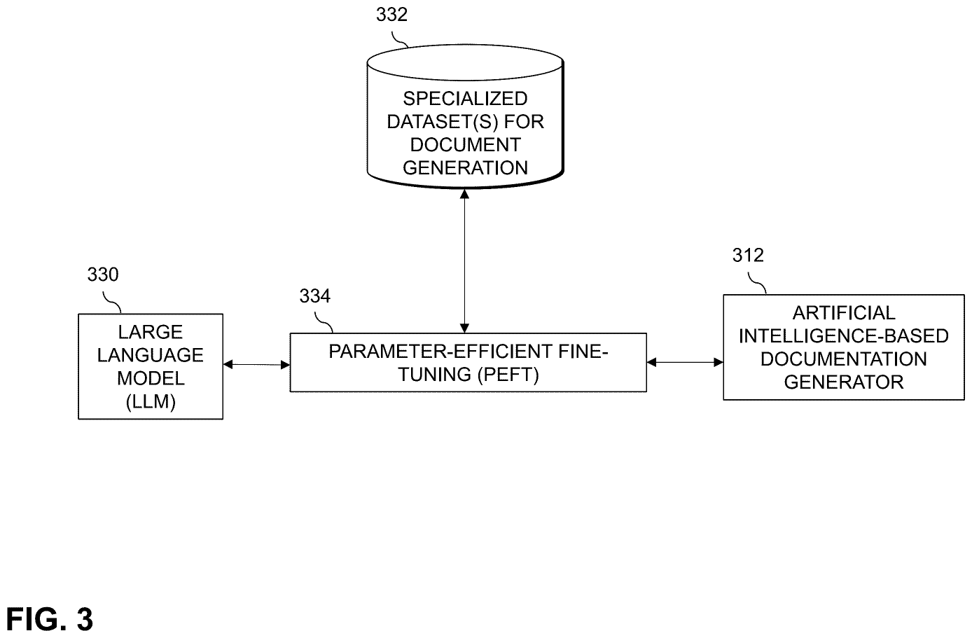

FIG. 3 shows an example workflow to fine-tune an LLM as part of artificial intelligence-based documentation generator implementation in an illustrative embodiment. By way of illustration, FIG. 3 depicts fine-tuning LLM 330 using, in step 334, one or more PEFT techniques such as, for example, LoRA, in conjunction with one or more specialized datasets for document generation 332. Once fine-tuned, the fine-tuned LLM is incorporated into and/or implemented as part of artificial intelligence-based documentation generator 312.

For fine-tuning data, at least one embodiment can include utilizing datasets enriched with technical literature, documentations, and/or optimal usage of one or more git portals with well-documented issues and releases. Such data can be collected, for example, from highly ranked open-source projects (e.g., using repository stars on GitHub). By way merely of illustration, one or more embodiments can include utilizing datasets containing data which extend beyond code repositories to a broader range of structured data, aligning with one or more software development life cycles. Accordingly, beyond code repositories, such a dataset can include data pertaining to corresponding project issues, tasks, comments, commits, code changes, and releases as they relate to changes in technical documentation. Such an integrated dataset allows an LLM to understand codebases, linking codebases with tagged features and issues, capturing more of the backdrop of a given project. Additionally, in at least one embodiment, a part of such a fine-tuning dataset (e.g., 5% of the dataset) can be used as a validation set to evaluate the performance of the model during and after training.

Additionally or alternatively, at least one embodiment can include using supervised fine-tuning (SFT) for full parameter, which includes full fine-tuning of a base model using non-trivial data and computational resources, whereas LoRA injects one or more trainable layers in the model and freezes the existing weights of the base model, rendering such a technique resource-efficient for the model's fine-tuning requirements.

By way merely of example, in one or more embodiments, LoRA can use two matrices, matrix A and matrix B, to represent weight updates through low-rank decomposition (r) hyperparameter, in connection with Equation (1) as follows:

$${W}_{o} + Δ W = {W}_{o} + BA \qquad ( 1 )$$

wherein Wₒ∈ [symbol] ^{d×k} represents the original weight matrix of the selected pre-trained model with dimension d×k. Also, W represents the updated weight matrix after applying the LoRA technique.

Additionally, the weight update matrices (e.g., the low rank matrices used to represent weight updates) are represented by B∈ [symbol] ^{d×r} and A∈ [symbol] ^{r×k}, and the starting hyperparameter can be taken, for example, as r=4 (wherein r represents the rank of the low rank adaptation), in connection with Equation (2) as follows:

$$h ( output ) = {W}_{o} x + BAx \qquad ( 2 )$$

wherein h represents an output embedding layer which includes the final output vector obtained after applying both the original weights and the low rank updates (BA) to x, which represents the input. In other words, h can represent the output of the neural network layer after applying a LoRA algorithm, and h can be used to generate the final output of the model.

In one or more embodiments, data used to fine-tune at least one LLM can include structured pairs of prompts (e.g., input) and expected responses (e.g., output). These structured pairs can be arranged, for example, from one or more repositories and/or platforms such as detailed herein. In such an embodiment, properly formatted code excerpts, associated comments from developers, issue reports, bug descriptions, deployment notes, commit logs, etc., can serve as input prompts, while formal descriptions of the referenced code, version logs, issue resolutions, deployment states, story features, overall documentation, etc., can comprise the expected responses. Additionally, in at least one embodiment, a chat-based functionality can be incorporated as an extension to the documentation generation.

For fine-tuning at least one LLM, at least one embodiment can include utilizing, for example, datasets enriched with technical literature, documentations, and optimal usage of git portals with documented issues and releases. Such data can be collected from highly ranked (e.g., using repository stars on GitHub) projects. Beyond repositories, such datasets can also include data pertaining to corresponding project issues, tasks, comments, commits, code changes, and releases as they relate to the changes in the technical documentation. Such integrated datasets facilitate the at least one LLM's ability to learn and/or understand codebases, linking the codebases with tagged features and/or issues.

One or more embodiments can also include validating the at least one fine-tuned LLM. For example, such an embodiment can include using a portion of the training/fine-tuning dataset (e.g., five percent of the dataset) as a validation set to evaluate the performance of the LLM during and after fine-tuning.

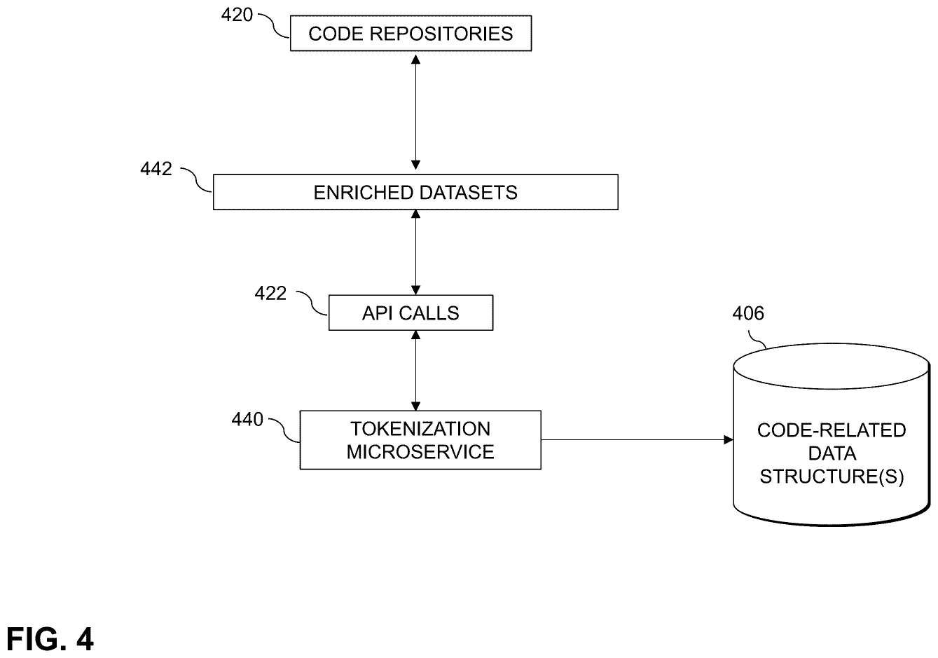

FIG. 4 shows an example workflow for processing data for LLM fine-tuning in an illustrative embodiment. By way of illustration, FIG. 4 depicts fetching enriched datasets 442 (e.g., data enriched with technical information pertaining to code development) from code repositories 420 using one or more API calls 422 (e.g., one or more REST API calls). In one or more embodiments, enriched datasets 442 can include code-related data pertaining to issues, tasks, comments, commits, code changes, releases, etc.

As also depicted in FIG. 4, in connection with fine-tuning at least one LLM, data from the enriched datasets 442 can be, via API calls 422, tokenized using tokenization microservice 440. In at least one embodiment, tokenization microservice 440 processes input data such as, e.g., code, release tags, branches, commits, issues, etc., and generates output data such as, e.g., user notes, formal release notes, readme files, etc., and stores such output data in code-related data structure(s) 406. Further, in one or more embodiments, the selection of the particular tokenizer (as part of tokenization microservice 440) is contingent upon the LLM(s) in question. In such an embodiment, the tokenizer used during a pre-training of the chosen LLM(s) can be employed during the fine-tuning phase to maintain consistency.

As also depicted in FIG. 4 and noted above, the output(s) of tokenization microservice 440 can be provided to and/or stored in code-related data structure(s) 406 for future use and/or processing. For example, such output data can subsequently be used to fine-tune one or more LLMs (e.g., one or more LLMs related to and/or associated with the code repositories 420 and/or the enriched datasets 442).

As detailed herein, one or more embodiments include implementing an automated update mechanism. By way of example, to update documentation based on changes in the corresponding code, project management data, deployment data, feature data, defect data, etc., can be leveraged with the use of one or more webhooks, which allow for notifications to be triggered between applications when a certain triggering event occurs. Also, such an embodiment can include using at least one VCS (e.g., GitLab) and/or at least one ALM tool (e.g., Jira) to configure and/or set-up one or more webhooks on one or more events (e.g., commit events, merge events, etc.).

Additionally, at least one embodiment can include utilizing at least one web application, server, service function and/or third-party service capable of receiving and processing incoming webhook payloads. In such an embodiment, the webhook uniform resource locators (URLs) are configured to point to at least one webhook receiver. The obtained payload(s), obtained after webhook triggers, contain information about the corresponding event(s). The webhook receiver(s) can parse the payload(s) to extract relevant data and pass such data to a data harbor for further preprocessing before ultimately being passed to at least one LLM (as part of artificial intelligence-based documentation generator) to be incorporated, at least in part, into the corresponding documentation as an update.

FIG. 5 is a flow diagram of a process for automatically generating software development documentation using artificial intelligence techniques in an illustrative embodiment. It is to be understood that this particular process is only an example, and additional or alternative processes can be carried out in other embodiments.

In this embodiment, the process includes steps 500 through 504. These steps are assumed to be performed by the automated software development documentation generation system 105 utilizing elements 112, 114 and 116.

Step 500 includes compiling, from one or more data sources, information pertaining to at least one set of software code in one or more data structures. In at least one embodiment, compiling information pertaining to at least one set of software code in one or more data structures includes compiling, in the one or more data structures, information related to one or more of at least one codebase associated with the at least one set of software code, one or more commits associated with the at least one set of software code, one or more code branches associated with the at least one set of software code, and one or more CICD pipelines associated with the at least one set of software code. Additionally or alternatively, compiling information pertaining to at least one set of software code in one or more data structures can include compiling, in the one or more data structures, information related to at least one of one or more issues associated with the at least one set of software code, one or more defects associated with the at least one set of software code, one or more deployed versions of the at least one set of software code, and existing documentation associated with the at least one set of software code.

Step 502 includes generating documentation associated with development of the at least one set of software code by processing at least a portion of the information in the one or more data structures using one or more artificial intelligence techniques. In one or more embodiments, generating documentation associated with the development of the at least one set of software code includes processing at least a portion of the information in the one or more data structures using at least one LLM. In such an embodiment, processing at least a portion of the information in the one or more data structures using at least one LLM can include processing at least a portion of the information in the one or more data structures using at least one LLM fine-tuned using technical information related to the at least one set of software code.

Additionally or alternatively, in one or more embodiments, the one or more data structures comprise multiple data structures, with each data structure associated with a distinct category of code-related information, and generating documentation associated with the development of the at least one set of software code includes combining one or more portions of the code-related information from each of two or more of the multiple data structures.

Step 504 includes performing one or more automated actions based at least in part on one or more portions of the generated documentation associated with the development of the at least one set of software code. In at least one embodiment, performing one or more automated actions includes automatically training at least a portion of the one or more artificial intelligence techniques using feedback related to the generated documentation associated with the development of the at least one set of software code. Additionally or alternatively, performing one or more automated actions can include automatically transmitting the generated documentation associated with the development of the at least one set of software code to one or more code repositories related to the at least one set of software code.

In one or more embodiments, the techniques depicted in FIG. 5 can also include detecting one or more changes associated with the at least one set of software code using at least one webhook-based technique. Such an embodiment can additionally include modifying at least a portion of the generated documentation associated with the development of the at least one set of software code based at least in part on the one or more detected changes associated with the at least one set of software code.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate software development documentation using artificial intelligence techniques. These and other embodiments can effectively overcome problems associated with error-prone and resource-intensive efforts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

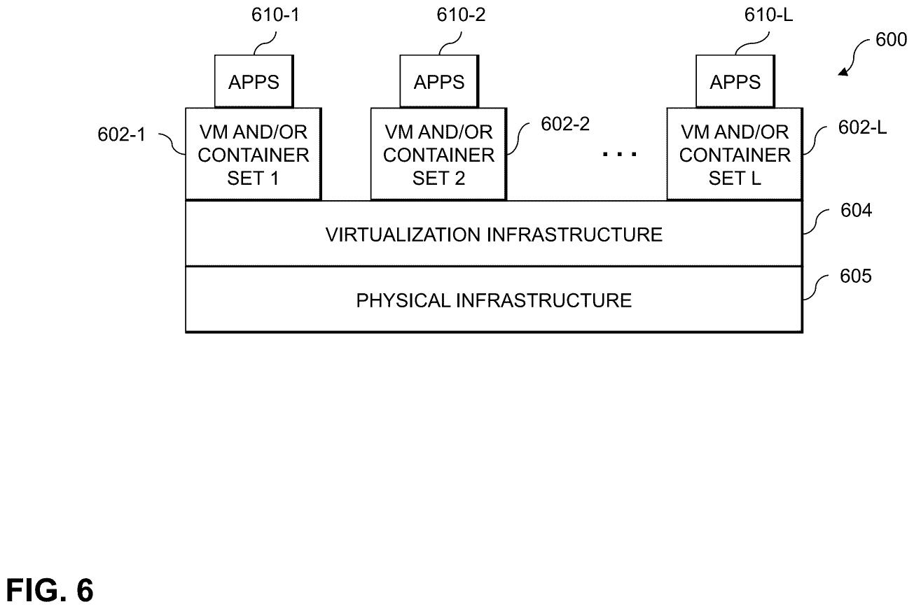

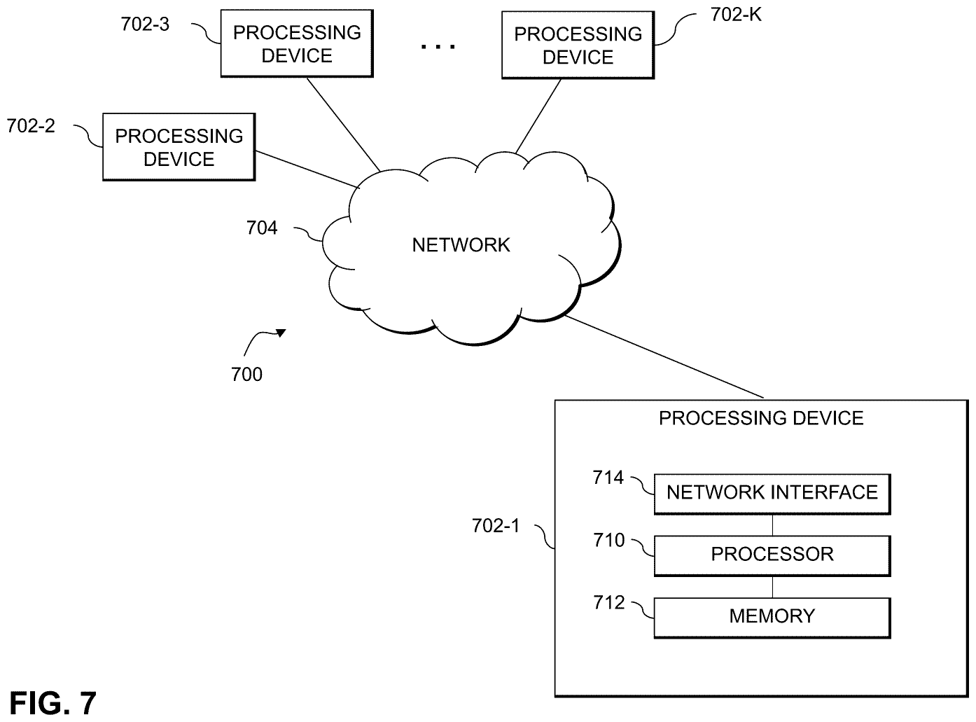

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises RAM, ROM or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
compiling, from one or more data sources, information pertaining to at least one set of software code in one or more data structures;
generating documentation associated with development of the at least one set of software code by processing at least a portion of the information in the one or more data structures using one or more artificial intelligence techniques; and
performing one or more automated actions based at least in part on one or more portions of the generated documentation associated with the development of the at least one set of software code;
wherein the method is performed by at least one processing device comprising a processor coupled to a memory.

2. The computer-implemented method of claim 1, further comprising:
detecting one or more changes associated with the at least one set of software code using at least one webhook-based technique.

3. The computer-implemented method of claim 2, further comprising:
modifying at least a portion of the generated documentation associated with the development of the at least one set of software code based at least in part on the one or more detected changes associated with the at least one set of software code.

4. The computer-implemented method of claim 1, wherein generating documentation associated with the development of the at least one set of software code comprises processing at least a portion of the information in the one or more data structures using at least one large language model (LLM).

5. The computer-implemented method of claim 4, wherein processing at least a portion of the information in the one or more data structures using at least one LLM comprises processing at least a portion of the information in the one or more data structures using at least one LLM fine-tuned using technical information related to the at least one set of software code.

6. The computer-implemented method of claim 1, wherein the one or more data structures comprise multiple data structures, each data structure associated with a distinct category of code-related information, and wherein generating documentation associated with the development of the at least one set of software code comprises combining one or more portions of the code-related information from each of two or more of the multiple data structures.

7. The computer-implemented method of claim 1, wherein performing one or more automated actions comprises automatically training at least a portion of the one or more artificial intelligence techniques using feedback related to the generated documentation associated with the development of the at least one set of software code.

8. The computer-implemented method of claim 1, wherein performing one or more automated actions comprises automatically transmitting the generated documentation associated with the development of the at least one set of software code to one or more code repositories related to the at least one set of software code.

9. The computer-implemented method of claim 1, wherein compiling information pertaining to at least one set of software code in one or more data structures comprises compiling, in the one or more data structures, information related to one or more of at least one codebase associated with the at least one set of software code, one or more commits associated with the at least one set of software code, one or more code branches associated with the at least one set of software code, and one or more continuous integration and continuous delivery (CICD) pipelines associated with the at least one set of software code.

10. The computer-implemented method of claim 1, wherein compiling information pertaining to at least one set of software code in one or more data structures comprises compiling, in the one or more data structures, information related to at least one of one or more issues associated with the at least one set of software code, one or more defects associated with the at least one set of software code, one or more deployed versions of the at least one set of software code, and existing documentation associated with the at least one set of software code.

11. A non-transitory processor-readable storage medium having stored therein program code of one or more software programs, wherein the program code when executed by at least one processing device causes the at least one processing device:
to compile, from one or more data sources, information pertaining to at least one set of software code in one or more data structures;
to generate documentation associated with development of the at least one set of software code by processing at least a portion of the information in the one or more data structures using one or more artificial intelligence techniques; and
to perform one or more automated actions based at least in part on one or more portions of the generated documentation associated with the development of the at least one set of software code.

12. The non-transitory processor-readable storage medium of claim 11, wherein the program code when executed by the at least one processing device further causes the at least one processing device:
to detect one or more changes associated with the at least one set of software code using at least one webhook-based technique.

13. The non-transitory processor-readable storage medium of claim 12, wherein the program code when executed by the at least one processing device further causes the at least one processing device:
to modify at least a portion of the generated documentation associated with the development of the at least one set of software code based at least in part on the one or more detected changes associated with the at least one set of software code.

14. The non-transitory processor-readable storage medium of claim 11, wherein generating documentation associated with the development of the at least one set of software code comprises processing at least a portion of the information in the one or more data structures using at least one LLM.

15. The non-transitory processor-readable storage medium of claim 14, wherein processing at least a portion of the information in the one or more data structures using at least one LLM comprises processing at least a portion of the information in the one or more data structures using at least one LLM fine-tuned using technical information related to the at least one set of software code.

16. An apparatus comprising:
at least one processing device comprising a processor coupled to a memory;
the at least one processing device being configured:
to compile, from one or more data sources, information pertaining to at least one set of software code in one or more data structures;
to generate documentation associated with development of the at least one set of software code by processing at least a portion of the information in the one or more data structures using one or more artificial intelligence techniques; and
to perform one or more automated actions based at least in part on one or more portions of the generated documentation associated with the development of the at least one set of software code.

17. The apparatus of claim 16, wherein the at least one processing device is further configured:
to detect one or more changes associated with the at least one set of software code using at least one webhook-based technique.

18. The apparatus of claim 17, wherein the at least one processing device is further configured:
to modify at least a portion of the generated documentation associated with the development of the at least one set of software code based at least in part on the one or more detected changes associated with the at least one set of software code.

19. The apparatus of claim 16, wherein generating documentation associated with the development of the at least one set of software code comprises processing at least a portion of the information in the one or more data structures using at least one LLM.

20. The apparatus of claim 19, wherein processing at least a portion of the information in the one or more data structures using at least one LLM comprises processing at least a portion of the information in the one or more data structures using at least one LLM fine-tuned using technical information related to the at least one set of software code.
